(19) United States
(12) Patent Application Publication
(10) Pub. No.: US 2023/0019462 A1
(43) Pub. Date: Jan. 19, 2023

(54) MPC-Based Trajectory Tracking of a First Vehicle Using Trajectory Information on a Second Vehicle

(71) Applicant: ZF Friedrichshafen AG, Friedrichshafen (DE)

(72) Inventor: Timon Busse, München (DE)

(21) Appl. No.: 17/783,879

(22) PCT Filed: Dec. 10, 2019
(86) PCT No.: PCT/EP2019/084388

§ 371 Date: Jun. 9, 2022

(51) Int. Cl. B60W 50/00

(52) U.S. Cl. CPC B60W 50/0097; B60W 2554/4041; B60W 2554/802; B60W 2555/60

(57) ABSTRACT

Determination of a trajectory for a first vehicle (1) by model predictive control (MPC) is provided. Trajectory information about a second vehicle (18) traveling in the area ahead of the first vehicle (1) is utilized. In particular, discretization points (P₁, P₂, P₃) and arrival times of the vehicles (1, 18) at the discretization points (P₁, P₂, P₃) are utilized to generate constraints for the model predictive control of the first vehicle (1).

### CROSS-REFERENCE TO RELATED APPLICATION

The present application is a U.S. national phase of PCT/EP2019/084388 filed in the European Patent Office on Dec. 10, 2019, which is incorporated by reference in its entirety for all purposes.

### FIELD OF THE INVENTION

The invention relates generally to the determination of a trajectory for a first vehicle by model predictive control (MPC). In particular, trajectory information about a second vehicle traveling in the area ahead of the first vehicle is utilized. In this context, a processor unit, a driver assistance system, a vehicle, a method, and a computer program product are claimed in particular.

### BACKGROUND

It is known with respect to adaptive cruise control (ACC) to also take efficiency criteria into account in the planning of speed trajectories. A rapidly growing approach in this regard is trajectory planning by an MPC solver. In this approach, a plurality of possible trajectories across a virtual horizon is evaluated with respect to overall efficiency. In this connection, other road users can also exert an influence on the overall efficiency of the ultimately selected trajectory. This is the case, for example, when a preceding vehicle initiates a braking operation or travels more slowly and, as a result, reduces the solution space of the MPC solver of the ego vehicle, which is why the ego vehicle is forced onto a less optimal trajectory. A basic problem in this connection is that it is generally not known to the ego vehicle how a preceding vehicle will behave.

Omchaudhuri Baisravan et al (AMERICAN CONTROL CONFERENCE (ACC), AMERICAN AUTOMATIC CONTROL COUNCIL, 10 Jul. 2019, pages 5557-5562, XP033605384) describe in “A Control Strategy for Driver Specific Driver Assistant System to Improve Fuel Economy of Connected Vehicles in Urban Roads” a fuel-efficient, driver-specific control strategy for a driver assistance system for multiple networked vehicles under urban road conditions. The control strategy is to function in a driver assistance system in which the controller gives the driver commands that he/she is to follow and, in so doing, takes into account the ability of the driver to follow the control commands. The provided method utilizes vehicle-to-vehicle communication (V2V), takes advantage of the signal phase and timing (SpaT) information of traffic lights, models the injection of driver errors with a Markov chain, and utilizes a stochastic, predictive model control based on scenarios in order to improve the fuel consumption and the mobility of the vehicle. The provided strategy is of a distributed nature, since each vehicle evaluates its own strategy using only locally available information. The simulation results show an improvement of the fuel efficiency when driver errors are taken into account in the synthesis of fuel-efficient controllers in a driver-assisting way.

WO 2019/185714 A1 teaches a method for generating a target operational speed band for a host vehicle traveling along a route. A first time-dependent obstacle is identified at a first location on the route. The first time-dependent obstacle is identified as an obstacle that is hindering the progress of the vehicle during a first time period. The first time-dependent obstacle is defined in a two-dimensional speed against distance map. A first speed trajectory is determined from a first point to a second point within the two-dimensional speed against distance map. The second point represents the first location on the route and the determined first speed trajectory represents the guest vehicle arriving at a first location at a first arrival time. The target operational speed band is determined such that the first speed curve forms either an upper limit or a lower limit of the target operational speed band. The first arrival time is outside the first time period.

US 2019/071096 A1 discloses a method for determining an optimal speed for a first vehicle preceded by a second vehicle. For this method, the position, the speed, and the acceleration of the second vehicle are measured in order to determine the trajectory thereof, and a dynamic model of the first vehicle is constructed. The speed to be reached is then determined by minimizing the energy consumption of the vehicle by the dynamic model, the minimization being constrained by the trajectory of the second vehicle.

### SUMMARY OF THE INVENTION

Example aspects of the present invention provide an MPC for a first motor vehicle, wherein the behavior of a second motor vehicle, which is traveling ahead of the first vehicle, is taken into account.

According to example aspects of the present invention, an exchange between various vehicles with respect to respective planned speed trajectories is provided. In particular, a V2V communication process can be used for utilizing V2V information in an MPC-based longitudinal driving strategy. A V2V communication can be understood to be an exchange of information and data between vehicles. The objective thereof is to signal critical and dangerous situations to the vehicles and/or respective drivers at an early point in time. The V2V information can be integrated into an MPC-based driving strategy, wherein the V2V information is utilized in the form of a trimming of the MPC solution space. Consequently, an improved selection of an optimal longitudinal speed trajectory is made possible.

In other words, example aspects of the present invention proposes identifying a communication strategy with other road users, which permits an integration into a model predictive control. The proposed solution can take place, in particular, assuming that the ego vehicle as well as the preceding vehicle follow a longitudinal driving strategy, as the result of which an interaction of multiple MPC solvers can take place. The subject matter of the invention may include the exchange between the various vehicles with respect to the planned speed trajectories. An MPC-based driving strategy is utilized as the basis therefor. Within the scope of this strategy, a virtual travel horizon is generated in the ego vehicle. Hard constraints, which trim the solution space of the MPC solver, can be introduced on this horizon. This is achieved, in particular, due to the indication of minimum arrival times or maximum arrival times at various discretization points along the virtual horizon.

In this sense, according to a first example aspect of the invention, a processor unit for a first vehicle is provided. The processor unit is configured for determining a trajectory for the first vehicle by model predictive control and, in fact, by utilizing trajectory information about a second vehicle, which is traveling in the area ahead of the first vehicle. The second vehicle is a preceding vehicle with respect to the first vehicle. The feature “trajectory for the first vehicle” can be understood to be a path that the first vehicle is to follow in the future, for example, within the next few seconds. A speed profile can be associated with the path, wherein the speed profile can predefine a target speed for the first vehicle for each waypoint or discretization point along the path. This assignment made up of path and speed yields the speed trajectory of the first vehicle.

The processor unit for the first vehicle is configured for selecting first discretization points from a totality of possible discretization points, which are located within a virtual travel horizon of a model predictive control of the first vehicle, and transmitting these first discretization points to a processor unit of the second vehicle, wherein the selected first discretization points are not located behind the second vehicle.

The discretization points represent, in particular, waypoints within the virtual travel horizon, in particular in an area ahead of the vehicle. The virtual travel horizon can be understood to be, in particular, a prediction horizon of the model predictive control of the first vehicle. In a first selection step, the discretization points located behind the second vehicle are sorted out by the processor unit of the first vehicle. The sorting-out of the discretization points can be carried out over a distance between the first vehicle and the second vehicle. The selected first discretization points are transmitted to the processor unit of the second vehicle.

The selected first discretization points are located ahead of a rear end of the second vehicle. The rear end of the second vehicle can form a rear-side termination of the second vehicle. The rear end of the second vehicle can be, for example, a bumper at the rear of the second vehicle. The first discretization points can also be located ahead of the rear end as well as ahead of a front end of the second vehicle, wherein the front end of the second vehicle can form a front-side termination of the second vehicle. Moreover, the first discretization points can be located between the rear end and the front end of the second vehicle.

Once the processor unit of the first vehicle has selected the first discretization points, the processor unit can transmit the selected first discretization points to the processor unit of the second vehicle. For this purpose, the processor unit of the first vehicle can include, for example, an appropriately configured communication interface, which, conversely, also enables the reception of data, in particular from the processor unit of the second vehicle, as described in greater detail in the following.

The processor unit of the first vehicle is configured for obtaining, from the processor unit of the second vehicle, an arrival time of the second vehicle at the relevant second discretization point ascertained by the processor unit of the second vehicle for each of the second discretization points selected by the second processor unit from the first discretization points, wherein all selected second discretization points are located ahead of the second vehicle.

The processor unit of the second vehicle can include a communication interface, by which the selected first discretization points can be received from the processor unit of the first vehicle and the aforementioned arrival times of the second vehicle at the second discretization points as well as information about the length of the second vehicle can be transmitted to the first processor unit. The processor unit of the second vehicle selects, from the first discretization points, those discretization points that are located ahead of the second vehicle. For this purpose, the processor unit of the second vehicle can access information about the length of the second vehicle, wherein the length can be added, for example, to the rear end of the second vehicle. In addition, the processor unit of the second vehicle ascertains an arrival time of the second vehicle for each of the selected second discretization points, i.e., when the second vehicle arrives at the relevant second discretization point. The length of the second vehicle as well as the second discretization points selected by the processor unit of the second vehicle, including associated arrival times, can be transmitted to the processor unit of the first vehicle.

The processor unit of the first vehicle is configured for generating a trajectory data set for the first vehicle. The trajectory data set includes the second discretization points selected by the second processor unit from the first discretization points and the arrival times of the second vehicle at the relevant second discretization points ascertained by the second processor unit. The trajectory data set also includes zeroed value pairs, wherein the zeroed value pairs each include a first discretization point that is not located ahead of the second vehicle as well as the value zero seconds. Therefore, the ascertained arrival times of the second vehicle at the second discretization points, which have been generated by the processor unit of the second vehicle, are re-used for the trajectory data set of the first vehicle. These values still must be supplemented, however, by the discretization points that are located between the preceding vehicle and the ego vehicle, so that an MPC algorithm is capable of processing these.

The processor unit of the first vehicle is configured for determining a trajectory for the first vehicle by model predictive control by executing an appropriate MPC algorithm, which includes a longitudinal dynamic model of the first vehicle and a cost function to be minimized, such that the cost function is minimized, wherein the trajectory data set is taken into account as a constraint in the determination of the trajectory. At least one constraint for the model predictive control can be ascertained from the trajectory data set, wherein the constraint describes the driving behavior of the preceding vehicle. Due to this constraint, the solution space of the model predictive control is trimmed. The processor unit of the first vehicle is therefore configured for taking the trajectory data set into account as a constraint when it (i.e., the processor unit of the first vehicle) executes an MPC algorithm and, as a result, determines a trajectory for the first vehicle. The trajectory data set, which describes the trajectory of the preceding vehicle, can be specified to the MPC logic as a hard constraint. A hard constraint can be understood to be a constraint that absolutely must be observed in the determination of the trajectory for the first vehicle. The hard constraints can be introduced on the virtual travel horizon such that the solution space of the MPC solver is trimmed. As described in greater detail in the following, this can be achieved, for example, due to the indication of minimum arrival times or maximum arrival times at the various discretization points along the virtual travel horizon.

In other words, the trajectory data set can be forwarded to an MPC logic for planning an optimal driving trajectory of the first vehicle. The MPC logic plans, under consideration of the route topology, the traffic, and further surroundings information, an optimal speed trajectory for the first vehicle for the upcoming route section. The reduced or trimmed solution space can now be utilized as the basis for the identification of this speed trajectory. In other words, the speed trajectory for the first vehicle can be refined and, as a result, improved, under consideration of the value pairs within the trajectory data set, which describes the trajectory of the preceding vehicle. In this way, an integrated optimization of various degrees of freedom is also possible, which results in driving behavior that is optimal as a whole. The described process can be repeated in a cycle period that is established in advance. As a result, it can be ensured that the newest driving information of the preceding second vehicle is utilized at any time for planning the trajectory of the first vehicle.

The method of model predictive control (MPC) makes it possible to find, in any situation under established marginal conditions and constraints, an optimal solution for a “driving efficiency” driving function that provides an efficient driving style. The MPC method is based on a system model, in example aspects of the present invention on a longitudinal dynamic model of the first vehicle, which describes the behavior of the system. In addition, the MPC method is based on an objective function or on a cost function that describes an optimization problem and determines which state variables are to be minimized.

The longitudinal dynamic model can represent a drive train of the vehicle and include a vehicle model with vehicle parameters and drive train losses (in part, approximated characteristic maps). In addition, findings regarding upcoming route topographies (for example, curves and uphill grades) can be incorporated into the longitudinal dynamic model of the drive train. In addition, findings regarding speed limits on the upcoming route can also be incorporated into the dynamic model of the drive train. The MPC algorithm can include an MPC solver in the form of a software module.

The MPC solver can include instructions or program code, as the result of which the processor unit is instructed to determine—as a function of the longitudinal dynamic model, in particular, of the first vehicle, but also of the second vehicle—the trajectory of the relevant vehicle such that the cost function is minimized.

The processor unit can forward the optimized trajectory of the first vehicle to a software module (“target generator”). By this software module, the processor unit can convert the mathematically optimal planning of all available degrees of freedom into actually evaluatable component signals. By way of example, a speed trajectory of the first vehicle for the next five thousand meters (5000 m) can be optimally planned by the model predictive control. In this case, the target generator would “convert” the first (=actually necessary) speed value of this trajectory, for example, into a demand torque of an electric machine of the first vehicle. The component software can then operate with this value and regulate the intended speed.

According to one further example embodiment, a first term of the cost function includes an electrical energy weighted with a first weighting factor and predicted according to the dynamic model, which is provided within a prediction horizon by a battery of the drive train of the first vehicle for driving the electric machine. In addition, the cost function can include, as a second term, a driving time weighted with a second weighting factor and predicted according to the longitudinal dynamic model, which the first vehicle needs in order to cover the entire distance predicted within the prediction horizon. The processor unit can be configured for determining an input variable for the electric machine by executing the MPC algorithm as a function of the first term and as a function of the second term such that the cost function is minimized.

The state variables for the “driving efficiency” driving function can therefore be, for example, the vehicle speed or the kinetic energy, the energy remaining in the battery, and the driving time. Energy consumption and driving time can be optimized, for example, on the basis of the uphill grade of the upcoming route and constraints for speed and drive force, and on the basis of the current system state. The driving time, in addition to the overall loss or energy consumption, can also be minimized by the objective function and/or by the cost function of the “driving efficiency” driving strategy. As a result, depending on the selection of the weighting factors, a low speed cannot always be evaluated as optimal and, thus, the problem no longer exists that the resultant speed is always at the lower edge of the permitted speed. It is made possible that the driver influence is no longer relevant for the energy consumption and the driving time of the first vehicle, because the electric machine can be controlled by the processor unit based on the input variable, which is determined by executing the MPC algorithm. By the input variable, in particular, an optimal prime mover operating point of the electric machine can be set. As a result, a direct regulation of the optimal speed of the first vehicle can be carried out.

The cost function can have, in particular, exclusively linear and quadratic terms. As a result, the overall problem has the form of a quadratic optimization with linear constraints and a convex problem results, which can be solved well and quickly. The objective function or the cost function can be formulated with a weighting (weighting factors), wherein, in particular, an energy efficiency, a driving time, and a ride comfort are calculated and weighted. An energy-optimal speed trajectory for an upcoming horizon can be calculated online on the processor unit, which can form, in particular, an integral part of a central control unit of the first vehicle. By utilizing the MPC method, moreover, the target speed of the first vehicle can be cyclically recalculated based on the current driving mode and the upcoming route information.

Current state variables can be measured and appropriate data can be recorded and supplied to the MPC algorithm. In this way, route data from an electronic map can be updated, in particular cyclically, for a prediction horizon (for example, four hundred meters (400 m)) ahead of the first vehicle. The route data can include, for example, uphill grade information, curve information, and information about speed limits.

Moreover, a curve curvature can be converted, via a maximum permissible lateral acceleration, into a speed limit for the first vehicle. In addition, a position finding of the first vehicle can be carried out, in particular via a GNSS signal for the precise localization on the electronic map.

In one example embodiment, the arrival times of the second vehicle at the selected second discretization points ascertained by the processor unit of the second vehicle establish minimum time periods, prior to the end of which the first vehicle is not permitted to reach the relevant second discretization point. A relevant minimum time period specifies that the vehicle is not permitted to arrive at the waypoint or the discretization point, with which the minimum time period is associated, before the minimum time period has elapsed. In this way, the solution space for the solver is limited according to the environmental conditions. In one simple example, the processor unit can ascertain that the first vehicle is located at a first discretization point (for example, the current discretization point) at a first point in time (for example, at a current point in time) and at a discretization point fifty meters (50 m) farther away at a second point in time (for example, five seconds (5 s) later).

The processor unit of the second vehicle can now ascertain a first arrival time for the second vehicle at the first discretization point and a second arrival time of the second vehicle at the second discretization point. The ascertained first arrival time can be, for example, zero seconds (0 s), and the ascertained second arrival time can be five seconds (5 s) in the future. These arrival times can be minimum arrival times, i.e., the first vehicle is not permitted to arrive at the first discretization point before the ascertained first minimum arrival time (or prior to the end of an appropriately long minimum first time period up to the ascertained first arrival time). In a similar way—in the case of an ascertained minimum second arrival time—the first vehicle is not permitted to arrive at the second discretization point before the ascertained second minimum arrival time (or prior to the end of an appropriately long minimum second time period up to the ascertained first arrival time, for example, five seconds (5 s)). The MPC solver is not permitted to select a trajectory for the first vehicle, according to which the first vehicle arrives at the relevant waypoint or discretization point at the same time as or before the preceding second vehicle, since otherwise there would be the risk of the first vehicle driving into the second vehicle (collision). In other words, it is established that the first vehicle should leave at least five seconds (5 s) of time to reach the second waypoint fifty meters (50 m) farther away in order to avoid a collision with the second vehicle.

In one further example embodiment, the processor unit of the first vehicle is configured for selecting those first discretization points from the totality of possible discretization points, the distance of which to the first vehicle is greater than a distance between the first vehicle and the second vehicle. For example, the rear end of the second vehicle can be detected by a sensor of the first vehicle, for example, by a radar sensor. Alternatively or additionally, the rear end of the second vehicle can be ascertained by determining a position of the second vehicle, for example, based on a satellite-assisted position determination such as GPS. This position determination can be carried out by the second vehicle, for example, by the processor unit of the second vehicle. In a similar way, the processor unit of the first vehicle can also determine the position of the first vehicle. The processor unit of the first vehicle can be configured for accessing the certain position of the second vehicle and for ascertaining a distance between the first vehicle and the second vehicle from the position of the second vehicle and the position of the first vehicle.

In addition, the processor unit of the first vehicle can be configured for receiving information about the length of the second vehicle from the second processor unit of the second vehicle; selecting those third discretization points from the first discretization points, the distance of which to the first vehicle is smaller than the sum of the length of the vehicle and the distance between the first vehicle and the second vehicle; and assigning the value zero to each of the third discretization points and storing these as further zeroed value pairs in the trajectory data set. This example embodiment makes it possible for all discretization points to be deleted that are not located ahead of both vehicles. This example embodiment enables a considerable reduction of computing time as, for example, a method that applies “filter and replace/remove.” Computing time is very important in an optimization by model predictive control, since the quality of the solution that is found depends directly on the available computing capacity of the MPC solver.

In one further example embodiment, the processor unit of the first vehicle is configured for receiving a position and a switching time from the processor unit of a light signal system that is located in the area ahead of the first vehicle, wherein the switching time indicates when the light signal system changes from a first traffic light signal (for example, “green”) to a second traffic light signal (for example, “red”). The light signal system is, in particular, a traffic light. The traffic light can be configured for displaying traffic light signals, for example, “red”, “green” and, optionally, “yellow” or “red and yellow”. The processor unit of the first vehicle is configured for adding the position and the switc″ing t″me of the light signal system to the trajectory data set for the first vehicle. The processor unit of the second vehicle can include a communication interface, by which the position of the light signal system and the switching time can be transmitted to the first processor unit.

The switching time of the light signal system received from the processor unit of the light signal system can establish, in particular, a maximum time period, prior to the end of which the first vehicle must have reached the position at which the light signal system is located. The maximum time period specifies that the vehicle is not permitted to arrive at the waypoint or the discretization point, with which the maximum time period is associated, before the maximum time period has elapsed. In this way, the solution space for the solver is limited according to the environmental conditions. The traffic light can be located, for example, at a waypoint or discretization point fifty meters (50 m) away and still display the “green” traffic light signal for a maximum time period of twenty seconds (20 s). In this case, the maximum time period can be set, for example, at twenty seconds (20 s). This means that the MPC solver is not permitted to determine and select a trajectory for the first vehicle, according to which the first vehicle needs longer than twenty seconds (20 s) to travel to the traffic light, since otherwise there would be the risk of the first vehicle running through the red light.

According to a second example aspect of the invention, a driver assistance system is provided for carrying out a driver assistance function of a first vehicle, wherein the driver assistance system is configured for
accessing a trajectory for the first vehicle determined by a processor unit according to the first example aspect of the invention, and
carrying out a driver assistance function of the first vehicle by utilizing the trajectory for the first vehicle.

The driver assistance function includes an autonomous driving function or a semi-autonomous driving function. The autonomous driving function enables the vehicle to travel autonomously, i.e., without a vehicle occupant controlling the vehicle. The driver has handed over the control of the vehicle to the driver assistance system. Thus, the autonomous driving function includes the vehicle being configured—in particular by the processor unit for determining the trajectory of the vehicle or the processor unit of the driver assistance system—for carrying out, for example, steering, turn-signaling, acceleration and braking maneuvers without human intervention and controlling, by an open-loop system, in particular, external lighting and signaling, such as turn-signal lights of the vehicle. The semi-autonomous driving function can be understood as a driving function that assists a driver of the vehicle in the control of the vehicle, in particular during steering, turn-signaling, acceleration and braking maneuvers, wherein the driver still has the control of the vehicle.

According to a third example aspect of the invention, a first vehicle is provided, which includes a processor unit according to the first example aspect of the invention and a driver assistance system according to the second example aspect of the invention. The vehicle is, in particular, a motor vehicle, for example, an automobile (for example, a passenger car having a weight of less than three and a half tons (3.5 t)), a motorcycle, a motor scooter, a moped, a bicycle, an e-bike, a bus, or a truck (for example, having a weight of more than 3.5 t), or also a rail vehicle, a ship, or an aircraft, such as a helicopter or an airplane. The invention can also be utilized in small, lightweight electric motor vehicles for micromobility, wherein these motor vehicles are utilized, in particular, in city traffic and for the first mile and the last mile in rural areas.

The first mile and the last mile can be understood as all routes and paths that are located in the first and last links of a mobility chain. This is, for example, the path from home to the train station or the route from the train station to the workplace. In other words, the invention is usable in all areas of transportation, such as automotive, aviation, nautical science, astronautics, etc.

According to a fourth example aspect of the invention, a method is provided for determining a trajectory for a first vehicle by model predictive control by utilizing trajectory information about a second vehicle, which is traveling in the area ahead of the first vehicle. The method includes the following steps of
selecting first discretization points from a totality of possible discretization points, which are located within a virtual travel horizon of a model predictive control of the first vehicle, wherein the selection is carried out by a processor unit of the first vehicle, and wherein the selected first discretization points are located ahead of a rear end of the second vehicle,
transmitting the selected first discretization points to a processor unit of the second vehicle by the processor unit of the first vehicle,
selecting second discretization points from the first discretization points by the processor unit of the second vehicle, wherein all selected second discretization points are located ahead of the second vehicle,
generating selected value pairs by the processor unit of the second vehicle, wherein the selected value pairs each include one of the selected second discretization points and an arrival time of the second vehicle at the selected second discretization point ascertained by the processor unit of the second vehicle,
selecting second discretization points from the first discretization points by the processor unit of the second vehicle such that all selected second discretization points are located ahead of the second vehicle,
ascertaining an arrival time of the second vehicle at each of the selected second discretization points by the processor unit of the second vehicle,
transmitting the arrival time of the second vehicle at each of the selected second discretization points by the processor unit of the second vehicle,
generating a trajectory data set for the first vehicle by the processor unit of the first vehicle, wherein the trajectory data set includes the second discretization points selected by the second processor unit from the first discretization points and the arrival times of the second vehicle at the relevant second discretization points ascertained by the second processor unit, and wherein the trajectory data set also includes zeroed value pairs, wherein the zeroed value pairs each include a first discretization point that is not located ahead of the second vehicle as well as the value zero seconds, and
ascertaining a trajectory for the first vehicle by executing an MPC algorithm, which includes a longitudinal dynamic model of the first vehicle and a cost function to be minimized, by model predictive control such that the cost function is minimized, wherein the trajectory data set is taken into account as a constraint in the determination of the trajectory and wherein the determination of the trajectory is carried out by the processor unit of the first vehicle.

According to a fifth example aspect of the invention, a computer program product is provided for determining a trajectory for a first vehicle by model predictive control by utilizing trajectory information about a second vehicle, wherein the computer program product, when run on a processor unit of the first vehicle, instructs the processor unit to
select first discretization points from a totality of possible discretization points, which are located within a virtual travel horizon of a model predictive control of the first vehicle, and transmit these to a processor unit of the second vehicle, which is traveling in the area ahead of the first vehicle, wherein the selected first discretization points are located ahead of a rear end of the second vehicle,
obtain, from the processor unit of the second vehicle, an arrival time of the second vehicle at the relevant second discretization point ascertained by the processor unit of the second vehicle for each of the second discretization points selected by the second processor unit from the first discretization points, wherein all selected second discretization points are located ahead of the second vehicle,
generate a trajectory data set for the first vehicle, wherein the trajectory data set includes the second discretization points selected by the second processor unit from the first discretization points and the arrival times of the second vehicle at the relevant second discretization points ascertained by the second processor unit, and wherein the trajectory data set also includes zeroed value pairs, wherein the zeroed value pairs each include a first discretization point that is not located ahead of the second vehicle, as well as the value zero seconds, and
determine a trajectory for the first vehicle by model predictive control by executing an MPC algorithm, which includes a longitudinal dynamic model of the first vehicle and a cost function to be minimized, such that the cost function is minimized, wherein the trajectory data set is taken into account as a constraint in the determination of the trajectory.

The comments made in conjunction with the processor unit according to the first example aspect of the invention also apply similarly for the driver assistance system according to the second example aspect of the invention, for the first vehicle according to the third example aspect of the invention, for the method according to the fourth example aspect of the invention, and for the computer program product according to the fifth example aspect of the invention.

### BRIEF DESCRIPTION OF THE DRAWINGS

Exemplary embodiments of the invention are explained in greater detail in the following with reference to the diagrammatic drawing, wherein identical or similar elements are labeled with the same reference character, wherein

FIG. 1 shows a schematic of a first vehicle,

FIG. 2 shows a top view of a second vehicle, which is traveling on a first route section of a road ahead of the first vehicle according to FIG. 1,

FIG. 3 shows vectors for a first discretization point between the first vehicle and the second vehicle from FIG. 2,

FIG. 4 shows vectors for a second discretization point in the area of the second vehicle from FIG. 2,

FIG. 5 FIG. vectors for a third discretization point ahead of the second vehicle from FIG. 2, and

FIGS. 6 through 8 show schematics of a trimming of the solution space, and a subsequent optimization by a model predictive control.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

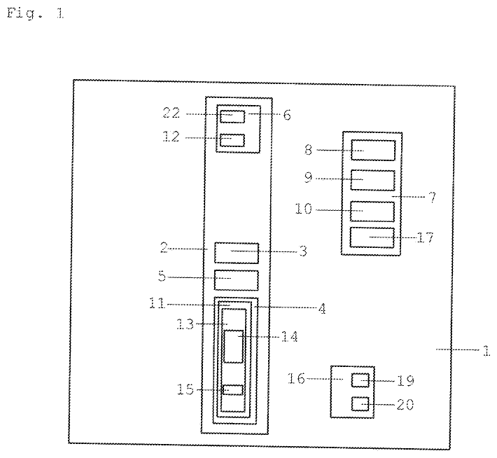

FIG. 1 shows a first vehicle 1. In the exemplary embodiment shown, the first vehicle 1 is a motor vehicle, for example, a passenger car. The first vehicle 1 includes an MPC system 2 for determining a trajectory for the first vehicle 1 by model predictive control by utilizing trajectory information about a second vehicle 18, which is represented in FIG. 2, wherein the second vehicle 18 is traveling ahead of the first vehicle 1. In the exemplary embodiment shown, the second vehicle 18 is also a motor vehicle, for example, also a passenger car. The first motor vehicle 1 also includes a driver assistance system 16 having a processor unit 19 and having a communication interface 20. The second vehicle 18 can have the same elements and functions as the first vehicle 1.

In the exemplary embodiment shown, the MPC system 2 includes a processor unit 3, a memory unit 4, a communication interface 5, and a detection unit 6 for detecting surroundings data and state data related to the first motor vehicle 1. The first motor vehicle 1 also includes a drive train 7, which can include, for example, an electric machine 8, which can be operated as a motor and as a generator, a battery 9, and a transmission 10. The electric machine 8, in the motor mode, can drive wheels of the motor vehicle 1 via the transmission 10, which can have, for example, a constant ratio. The battery 9 can provide the electrical energy necessary therefor. The battery 9 can be charged by the electric machine 8 when the electric machine 8 is operated in the generator mode (recuperation). Optionally, the battery 9 can also be charged at an external charging station. Likewise the drive train of the motor vehicle 1 can optionally include an internal combustion engine 17, which, alternatively or in addition to the electric machine 8, can drive the motor vehicle 1. The internal combustion engine 17 can also drive the electric machine 8 in order to charge the battery 9.

A computer program product 11 can be stored on the memory unit 4. The computer program product 11 can be run on the processor unit 3, for the purpose of which the processor unit 3 and the memory unit 4 are connected to each other by the communication interface 5. When the computer program product 11 is run on the processor unit 3, the computer program product 11 instructs the processor unit 3 to perform the functions described in conjunction with the drawing and/or to carry out method steps.

The computer program product 11 includes an MPC algorithm 13. The MPC algorithm 13 includes a longitudinal dynamic model 14 of the drive train 7 of the first motor vehicle 1. In addition, the MPC algorithm 13 includes a cost function 15 to be minimized. The processor unit 3 executes the MPC algorithm 13 and determines an optimal speed trajectory of the first motor vehicle 1 based on the longitudinal dynamic model 14 such that the cost function 15 is minimized.

In addition, an optimal rotational speed and an optimal torque of the electric machine 8 for discretization points in the prediction horizon can result as the output of the optimization by the MPC algorithm 13. For this purpose, the processor unit 3 can ascertain an input variable for the electric machine 8, enabling the optimal rotational speed and the optimal torque to set in. The processor unit 3 can control the electric machine 8 based on the ascertained input variable. In addition, this can also be carried out by the driver assistance system 16, however.

The detection unit 6 can measure current state variables of the first motor vehicle 1, record appropriate data, and supply these to the MPC algorithm 13. In addition, route data from an electronic map can be updated, in particular cyclically, for a prediction horizon (for example, 400 m) ahead of the motor vehicle 1. The route data can include, for example, uphill grade information, curve information, and information about speed limits. Moreover, a curve curvature can be converted, via a maximum permissible lateral acceleration, into a speed limit for the motor vehicle 1. In addition, a position finding of the first motor vehicle 1 can be carried out by the detection unit 6, in particular via a signal generated by a GNSS sensor 12 for the precise localization on the electronic map. Moreover, the detection unit 6 can includes a radar sensor 22, in particular for determining the position and/or speed of preceding vehicles 18 (FIG. 2). The processor unit 3 can access information of the aforementioned elements, for example, via the communication interface 5. This information can be incorporated into the longitudinal dynamic model 14 of the motor vehicle 1, in particular as constraints or side conditions.

The highly simplified two-dimensional (dimensions x, y) example according to FIG. 2 shows the first motor vehicle 1 on a road 21. The first motor vehicle 1 is traveling autonomously, assisted by the above-described driver assistance function, at a first speed v₁ in a first direction of travel x₁. The second motor vehicle 18 is also located on the road 21, ahead of the first motor vehicle 1. The second motor vehicle 18 is traveling ahead of the first motor vehicle 1 at a second speed v₂ in a second direction of travel x₂. In the exemplary embodiment shown, the first route section 22 extends straight and the first direction of travel x₁ of the first motor vehicle 1 corresponds to the second direction of travel x₂ of the second motor vehicle 18. This is purely by way of example and not mandatory, however. The first speed v₁ of the first motor vehicle 1 can correspond to the second speed v₂ of the second motor vehicle 18 (v₁=v₂), which is also purely by way of example and not mandatory, however. The first speed v₁ of the first motor vehicle 1 can also deviate from the second speed v₂ of the second motor vehicle 18 (v₁≠v₂). The second motor vehicle 18 is traveling ahead of the first motor vehicle 1. The first motor vehicle 1 is following the second motor vehicle 18.

The processor unit 3 of the first vehicle 1 generates a virtual travel horizon and/or a prediction horizon of the first vehicle 1. The virtual travel horizon includes a plurality of possible discretization points Pₓ, of which a first discretization point P₁, a second discretization point P₂, and a third discretization point P₃ are represented in FIG. 2. The discretization points Pₓ are waypoints P₁, P₂, P₃ in the area ahead of the first vehicle 1. The n possible discretization points Pₓ can be stored in an output data array \vec{s_{dlS}} as follows:

\vec{s_{dls}}=[P₁;P₂;P₃; . . . ;Pₙ].

For example, the distance \vec{d} of a front end 23 of the first vehicle 1 to a rear end 24 of the second vehicle 18, for example, to a rear bumper of the second vehicle 18, can be ascertained continuously or at discrete points in time in quick succession by the radar sensor 22. The processor unit 3 of the first vehicle 1 can access appropriate distance data of the radar sensor 22 by the communication interface 5. The distance \vec{d} can be twenty meters (20 m), purely by way of example, and indicated as a vector d. Likewise the three discretization points P₁, P₂, P₃ can be indicated as position vectors \vec{P₁}, \vec{P₂}, \vec{P₃}, which extend, for example, from the front end 23 of the first vehicle 1 to the respective discretization point P₁, P₂, P₃. The output data array \vec{s_{dls}} can therefore be represented as follows:

\vec{s_{dls}}=[\vec{P₁},\vec{P₂},\vec{P₃}].

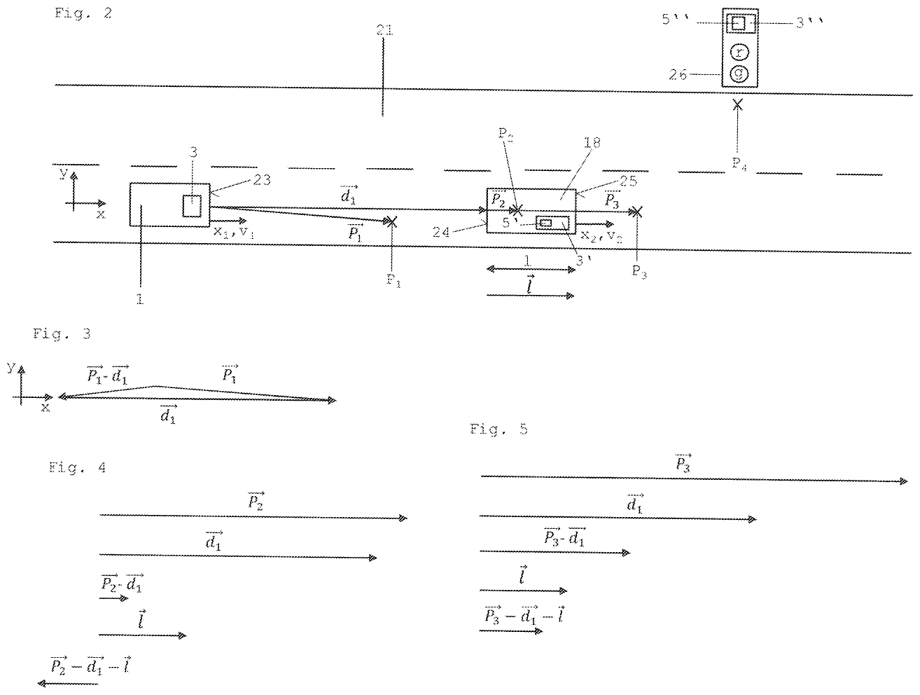

The processor unit 3 subtracts the distance vector d from each of the position vectors \vec{P₁}, \vec{P₂}, \vec{P₃}. The first discretization point P₁ is located, for example, fifteen meters (15 m) ahead of the front end 23 of the first vehicle 1 and behind the rear end 24 of the second vehicle 18. As shown in FIG. 3, this yields a difference vector \vec{P₁}−\vec{d}, which has a negative value relative to the forward direction x of the first vehicle 1 (negative vector component in the x direction; in this example having the value negative five meters (−5 m)). The second discretization point P₂ is located, for example, twenty-one meters (21 m) ahead of the front end 23 of the first vehicle 1 and, thus, between the rear end 24 of the second vehicle 18 and a front end 25 of the second vehicle 18, which, by way of example, has a length l of five meters (5 m). The length l of the second vehicle 18 can also be indicated using vectors (length vector \vec{l}, which has only one component in the x direction in the example shown). As shown in FIG. 4, this yields a difference vector \vec{P₂}−\vec{d}, which has a positive value relative to the forward direction x of the first vehicle 1 (positive vector component in the x direction; in this example having the value positive one meter (+1 m)). The third discretization point P₃ is located twenty-eight meters (28 m) ahead of the front end 23 of the first vehicle 1 and, thus, ahead of the front end 25 of the second vehicle 18. As shown in FIG. 5, this yields a difference vector \vec{P₃}−\vec{d}, which has a positive value relative to the forward direction x of the first vehicle 1 (positive vector component in the x direction; in this example having the value positive eight meters (+8 m)).

The output data array \vec{s_{dls}} can have, as an alternative to the vectorial entries, the aforementioned components of the position vectors P₁, P₂, P₃ in the x direction (forward direction of the first vehicle 1):

\vec{s_{dls}}=[15;21;28].

The processor unit 3 also stores the component values of the difference vectors in the x direction in a discretization data array \vec{s_{dls_V2V}}, which is then represented as follows:

\vec{s_{dls_V2V}}=[−5;1;8]

The processor unit 3 subsequently deletes all negative entries of the discretization data array \vec{s_{dsl_V2V}}. In this way, the processor unit 3 of the first vehicle selects first discretization points, which are included in the discretization data array \vec{s_{dls_V2V_1}}, which is relevant for the V2V communication and is represented as follows:

\vec{s_{dls_V2V_1}}=[1;8].

The processor unit 3 transmits this single-fold transformed discretization data array \vec{s_{dls_V2V_1}}=[1; 8] by the communication interface 5 to the processor unit 3′ of the second vehicle 18 via a communication interface 5′ of the second vehicle 18.

The processor unit 3′ of the second vehicle 18 subtracts the length l=5 m of the second vehicle 18 from each value of the single-fold transformed discretization data array \vec{s_{dsl_V2V_1}}=[1; 8]. This is vectorially represented in FIG. 4 and FIG. 5. As shown in FIG. 4, this yields a difference vector \vec{P₂}−\vec{d}−\vec{l}, which has a negative value relative to the forward direction x of the first vehicle 1 (negative vector component in the x direction; in this example having the value negative four meters (−4 m)). As shown in FIG. 5, this yields one further difference vector \vec{P₃}−\vec{d}−\vec{l}, which has a positive value relative to the forward direction x of the first vehicle 1 (positive vector component in the x direction; in this example having the value three meters (3 m)). The processor unit 3′ of the second vehicle 18 stores these differences in a two-fold transformed discretization data array \vec{s_{dls_V2V_2}}, which has the following entries:

\vec{s_{dls_V2V_2}}=[−4;3].

The processor unit 3′ of the second vehicle 18 subsequently deletes all negative entries of the two-fold transformed discretization data array \vec{s_{dls_V2V_2}} (selection of second discretization points), as the result of which a three-fold transformed discretization data array \vec{s_{dls_V2V_3}} results in the example shown, which is represented as follows:

\vec{s_{dls_V2V_3}}[3]

In this way, the single-fold transformed discretization data array \vec{s_{dls_V2V_1}}=[1; 8] is transformed into a discretization data array \vec{s_{dls_V2V_3}}, which is relevant for the processor unit 3′ of the second vehicle 18.

The processor unit 3′ of the second vehicle 18 subsequently calculates a planned arrival time of the second vehicle 18 at each discretization point of the three-fold transformed discretization data array \vec{s_{dls_V2V_3}}=[3] by interpolation, in the present example, therefore, only for the single entry “3” (meters). The type of interpolation depends on the preceding second vehicle 18. If the second vehicle 18 plans the trajectory of the second vehicle 18 by ACC, an interpolation by polynomial fitting is generally already present. This could be directly re-used for calculating the arrival time of the second vehicle at the third discretization point P₃ at a distance of three meters (3 m). If this is, for example, a vehicle of level 2 or higher (for example, Al-based), a linear interpolation can be advantageously utilized.

The processor unit 3′ of the second vehicle 18 subsequently generates an arrival data array \vec{t_{vec_min_ext}}, which includes selected value pairs, each of which is made up of the discretization points of the three-fold transformed discretization data array s_{dls_V2V_3} and a planned arrival time of the second vehicle 18 at the relevant discretization point of the three-fold transformed discretization data array \vec{s_{dls_V2V_3}}. In the example shown, only the planned arrival time of the second vehicle 18 at the third discretization point P₃, which is located three meters (3 m) ahead of the front end 25 of the second vehicle 2, is calculated and stored together with the third discretization point P₃ in the arrival data array t_{vec_min_ext}. If the second vehicle 18 moves, for example, at a constant speed of 30 kilometers per hour, the processor unit 3′ of the second vehicle 18 can calculate a planned arrival time t₃=0.36 s of the second vehicle 18 at the discretization point P₃ at a distance of three meters (3 m) away.

The arrival data array t_{vec_min_ext} is therefore represented as follows in the exemplary embodiment shown:

\vec{t_{vec_min_ext}}=[3,0.36].

The processor unit 3′ of the second vehicle 18 transmits this arrival data array \vec{t_{vec_min_ext}}=[28; 0,36] and the length l of the second vehicle 18 by the communication interface 5′ of the second vehicle 18 to the processor unit 3 of the first vehicle 1 via the communication interface 5 of the first vehicle 1.

The processor unit 3 of the first vehicle 1 subsequently identifies, by the length l of the second vehicle 18 and by the above-described distance d of the front end 23 of the first vehicle 1 to the rear end 24 of the second vehicle 18, those discretization points that are located ahead of the front end 25 of the second vehicle 18. This can be carried out in the same way as described in conjunction with the processor unit 3′ of the second vehicle 18 and illustrated by FIGS. 4 and 5 for the discretization points P₂ and P₃. This step can be omitted for the discretization point P₁, which has already been sorted out by the processor unit 3 of the first vehicle 1.

The processor unit 3 of the first vehicle 1 also generates a trajectory data set in the form of a minimum arrival data array \vec{t_{vec_min}} for the first vehicle 1. This includes, on the one hand, zeroed value pairs for all discretization points that are located behind the front end 25 of the second vehicle 18. In the example shown, the value zero seconds would be associated with the first discretization point P₁ and with the second discretization point P₂ (0 s or “0” in the minimum arrival data array \vec{t_{vec_min}} for the first vehicle 1). The processor unit 3 of the first vehicle 1 can establish the value 0 s as the minimum time period before which the first vehicle 1 is not allowed to arrive at the first discretization point P₁ and at the second discretization point P₂. The value 0 s means that the first vehicle 1 is permitted to arrive at the first discretization point P₁ and at the second discretization point P₂ at any point in time in the future, since the trajectories of the first vehicle 1 and of the second vehicle 18 do not meet at these discretization points P₁, P₂.

The processor unit 3 of the first vehicle 1 also transmits the arrival times of the value pairs of the minimum arrival data array \vec{t_{vec_min_ext}} for the second vehicle 18 in the minimum arrival data array \vec{t_{vec_min}} for the first vehicle 1 and, in fact, for all discretization points that are located ahead of the front end 25 of the second vehicle 18. In the example shown, this is only the third discretization point P₃. In this case as well, the processor unit 3 of the first vehicle 1 establishes the ascertained arrival time in thirty-six hundredths of a second (0.36 s) as the minimum time period before which the first vehicle 1 is not permitted to arrive at the third discretization point P₃. Therefore, it is ensured that the second vehicle 18 passes the third discretization point P₃ earlier than the first vehicle 1. In this way, a collision of the first vehicle 1 with the second vehicle 2 can be prevented. The minimum arrival data array \vec{t_{vec_min}} for the first vehicle 1 can therefore contain, for example, the following value pairs:

\vec{t_{vec_min}}=[15,0;21,0;28,0.36].

By executing the MPC algorithm 13, the processor unit 3 subsequently determines a trajectory for the first vehicle by model predictive control. The arrival data array \vec{t_{vec_min}} is taken into account as a constraint. The determination of the trajectory for the first vehicle 1 is carried out such that the cost function 15 is minimized. In addition, in particular, a route topology, the traffic, and further surroundings information are also taken into account in order to determine the optimal speed trajectory for the first vehicle 1 for the upcoming route section.

A light signal system in the form of a traffic light 26, which can display the “green” and “red” traffic light signals, for example, in alternation, is located at a fourth discretization point in the area ahead of the first vehicle 1, for example, on a position P₄ located forty meters (40 m) ahead of the first vehicle 1. The processor unit 3 of the first vehicle 1 can access this position P₄. For example, the traffic light 26 can include a processor unit 3″ and a communication interface 5″. By the communication interface 5″, the processor unit 3″ of the traffic light 26 can transmit the position P₄ and switching times to the processor unit 3 of the first vehicle 1, for example, that the traffic light 26 will change from “green” to “red” in twenty seconds (20 s). The processor unit 3 of the first vehicle 1 can store the position P₄ together with the switching time as a value pair in the arrival data array \vec{t_{vec_min}} for the first vehicle 1. The switching time of the light signal system 26 establishes a maximum time period, as a further constraint, before the end of which the first vehicle 1 must have reached the position P₄ of the light signal system 26. Alternatively, the processor unit 3 of the first vehicle 1 can store the position P₄ together with the switching time as a value pair in a new arrival data array \vec{t_{vec_max}} for the first vehicle 1, which, in contrast to the arrival data array t_{vec_min}, includes a maximum arrival time.

The processor unit 19 of the driver assistance system 16 accesses—by the communication interface 20—the trajectory for the first motor vehicle 1 determined by the processor unit 3 of the MPC system 2 and carries out the autonomous driving function of the first motor vehicle 1 by utilizing the trajectory for the first motor vehicle 1. Alternatively, the processor unit 3 of the MPC system 2 can also carry out the autonomous driving function of the first motor vehicle 1 by utilizing the trajectory for the first motor vehicle 1. In this case, the driver assistance system 16 is integrated into the MPC system 2 and the MPC system 2 forms the driver assistance system 16.

Possible embodiments of the longitudinal dynamic model 14 and of the cost function 15, which are integral parts of the MPC algorithm 13 for determining the trajectory for the first motor vehicle 1, are described in greater detail in the following.

The longitudinal dynamic model 14 of the motor vehicle 1 can be expressed mathematically as follows:

$$\frac{dv ( t )}{dt} = ( {F}_{trac} ( t ) - {F}_{r} ( α ( t ) ) - {F}_{gr} ( α ( t ) ) - {F}_{d} ( v ( t ) ) ) / {m}_{e q}$$

### Wherein:

v is the speed of the motor vehicle;
F_{trac} is the tractive force that is exerted by the prime mover or the brakes upon the wheels of the motor vehicle,
Fᵣ is the rolling resistance, which is an effect of the deformation of the tires during rolling and depends on the load of the wheels (on the normal force between the wheel and the road) and, thus, on the inclination angle of the road;
F_{gr} is the gradient resistance, which describes the longitudinal component of gravity, which acts upon the motor vehicle during operation uphill or downhill, depending on the gradient of the roadway;
F_{d} is the drag force of the motor vehicle; and
m_{eq} is the equivalent mass of the motor vehicle; the equivalent mass includes, in particular, the inertia of the turned parts of the drive train, which are subjected to the acceleration of the motor vehicle (prime mover, transmission input shafts, wheels).

By converting time dependence into distance dependence

$$\frac{d}{ds} = \frac{d}{dt} * \frac{dt}{ds} = \frac{d}{dt} * \frac{1}{v}$$

and coordinate transformation in order to eliminate the quadratic speed term in the aerodynamic drag with

$${e}_{kin} = \frac{1}{2} * {m}_{e q} * {v ( t )}^{2} ,$$

the result is

$$\frac{{de}_{kin}}{ds} = {F}_{trac} ( s ) - {F}_{r} ( α ( s ) ) - {F}_{gr} ( α ( s ) ) - {F}_{d} ( {e}_{k i n} ( s ) ) .$$

In order to ensure that the problem is quickly and easily solvable by the MPC algorithm 13, the dynamic equation of the longitudinal dynamic model 14 can be linearized, in that the speed is expressed, via coordinate transformation, by kinetic energy deₖᵢₙ. As a result, the quadratic term for calculating the aerodynamic drag F_{d} is replaced by a linear term and, simultaneously, the longitudinal dynamic model 14 of the motor vehicle 1 is no longer described as a function of time, as usual, but rather as a function of distance. This fits well with the optimization problem, since the predictive information of the electrical horizon is based on distance.

In addition to the kinetic energy, there are two further state variables, which, within the scope of a simple optimization problem, can also be described in a linear and distance-dependent manner. On the one hand, the electrical energy consumption of the drive train 7 is usually described in the form of a characteristic map as a function of torque and prime mover speed. In the exemplary embodiment shown, the motor vehicle has a fixed ratio between the electric machine 8 and the road on which the motor vehicle 1 moves. As a result, the rotational speed of the electric machine 8 can be directly converted into a speed of the motor vehicle 1 or even into a kinetic energy of the motor vehicle 1. In addition, the electrical power of the electric machine 8 can be converted into energy consumption per meter via division by the appropriate speed. In order to be able to utilize a corresponding characteristic map for the optimization, it is linearly approximated Energy_{perMeter}≥αᵢ*eₖᵢₙ+bᵢ*F_{trac} for all i.

The cost function 15 to be minimized can be expressed mathematically, for example, as follows:

$$min ( {w}_{Bat} \cdot {E}_{Bat} ( {s}_{E} ) + {w}_{Time} \cdot T ( {s}_{E} ) + {w}_{Tem} \cdot {{\sum }_{s = 1}}^{{s}_{E} - 1} {( \frac{{F}_{A} ( s ) - {F}_{A} ( s - 1 )}{Δ s} )}^{2} + {w}_{TemStart} \cdot {( {F}_{A} ( {s}_{1} ) - {F}_{A} ( {s}_{0} ) )}^{2} + {{\sum }_{s = 1}}^{{s}_{E} - 1} {w}_{Slack} \cdot {Var}_{slack} )$$

Wherein:
w_{Bat} is the weighting factor for the energy consumption of the battery
E_{Bat} is the energy consumption of the battery
S is the distance
S_{E-1} is the distance one time step before the end of the prediction horizon
F_{A} is the drive force that is provided by the electric machine, transmitted by a transmission at a constant ratio, and applied at a wheel of the motor vehicle
W_{Tem} is the weighting factor for torque gradients
W_{TemStart} is the weighting factor for torque surges
T is the time that the vehicle needs in order to cover the entire distance predicted within the prediction horizon
w_{Time} is the weighting factor for the time T
S_{E} is the distance to the end of the horizon
w_{slack} is the weighting factor for the slack variable
Var_{slack} is the slack variable

The cost function 15 has exclusively linear and quadratic terms in the exemplary embodiment shown. As a result, the overall problem has the form of a quadratic optimization with linear constraints and a convex problem results, which can be solved well and quickly.

The cost function 15 includes, as a first term, an electrical energy E_{Bat} weighted with a first weighting factor w_{Bat} and predicted according to the longitudinal dynamic model, which is provided within a prediction horizon by the battery 9 of the drive train 7 for driving the electric machine 8.

The cost function 15 includes, as one further term, a driving time T weighted with a second weighting factor W_{Time} and predicted according to the longitudinal dynamic model 14, which the motor vehicle 1 needs in order to cover the predicted distance. As a result, depending on the selection of the weighting factors, a low speed cannot always be evaluated as optimal and, thus, the problem no longer exists that the resultant speed is always at the lower edge of the permitted speed.

The energy consumption and the driving time can both be evaluated and weighted at the end of the horizon. These terms are therefore active only for the last point of the horizon.

Excessively high torque gradients within the horizon are disadvantageous.

Therefore, torque gradients are already penalized in the cost function 15, namely by the term

$${w}_{Tem} \cdot {\sum }_{s = 1}^{{s}_{E} - 1} {( \frac{{F}_{A} ( s ) - {F}_{A} ( s - 1 )}{Δ s} )}^{2} .$$

The quadratic deviation of the drive force per meter is weighted with a weighting factor W_{Tem} and minimized in the cost function. Alternatively to the drive force F_{A} per meter, the torque M_{EM} provided by the electric machine 8 can also be utilized and weighted with the weighting factor W_{Tem}, and so the alternative term

$${w}_{Tem} \cdot {\sum }_{s = 1}^{{s}_{E} - 1} {( \frac{{M}_{EM} ( s ) - {M}_{EM} ( s - 1 )}{Δ s} )}^{2}$$

results. Due to the constant ratio of the transmission 10, the drive force and the torque are directly proportional to one another.

In order to ensure comfortable driving, one further term is introduced in the cost function 15 for penalizing torque surges, namely w_{TemStart}·(F_{A}(s₁)−F_{A}(s₀))². Alternatively to the drive force F_{A}, the torque M_{EM} provided by the electric machine 8 can also be utilized here, and so the alternative term w_{TemStart}·(M_{EM}(S₁)−M_{EM}(S₀))² results. For the first point in the prediction horizon, the deviation from the most recently set torque can be evaluated as negative and weighted with a weighting factor W_{TemStart} in order to ensure that there is a seamless and smooth transition during the change-over between an old trajectory and a new trajectory.

Speed limits are hard limits for the optimization that are not permitted to be exceeded. A slight exceedance of the speed limits is always permissible in reality and tends to be the normal case primarily during transitions from one speed zone into a second zone. In dynamic surroundings, where speed limits shift from one computing cycle to the next computing cycle, it can happen, in the case of very hard limits, that a valid solution for a speed profile can no longer be found. In order to increase the stability of the computational algorithm, a soft constraint is introduced into the cost function 15. A slack variable Var_{slack} weighted with a weighting factor W_{Slack} becomes active in a predefined narrow range before the hard speed limit is reached. Solutions that are situated very close to this speed limit are evaluated as poorer, i.e., solutions, the speed trajectory of which maintains a certain distance to the hard limit.

In FIGS. 6 through 8, the horizontal x-axis corresponds to the distance s. The discretization points of the predictive horizon are selected on this distance. The stepped profile in FIG. 6 is a representation of a hard constraint, which aligns with these points. The constraint can have various dimensions. By way of example, it can be assumed that the speed limit is handled as a constraint (the model predictive control is not permitted to find a solution in which the selected speed is higher than the speed limit). In this case, the vertical y-axis corresponds to the speed and the stepped profile corresponds to the maximum permissible speed at the various discretization points.

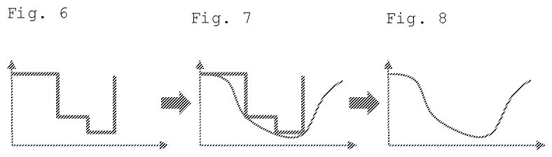

FIG. 7 shows that the model predictive control seeks and finds (red speed profile) an optimal solution in the trimmed solution space (below the speed limit) as a consequence of the data input with the selected constraints. In the third step, this is handed over to the vehicle controller and implemented, as shown by FIG. 8.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

d distance between the first vehicle and the second vehicle
\vec{d} distance vector
l length of second vehicle
\vec{l} length vector of second vehicle
P₁ first discretization point
P₂ second discretization point
P₃ third discretization point
P₄ position of the light signal system
\vec{P₁−d} difference vector of first discretization point—distance vector
\vec{P₂−d} difference vector of second discretization point—distance vector
\vec{P₃−d} difference vector of third discretization point—distance vector
\vec{P₁} position vector of first discretization point
\vec{P₂} position vector of second discretization point
\vec{P₃} position vector of third discretization point
v₁ speed of the first vehicle
x₁ direction of travel of the first vehicle
v₂ speed of the second vehicle
x₂ direction of travel of the second vehicle
1 first vehicle
2 MPC system
3 processor unit of the first vehicle
3′ processor unit of the second vehicle
3″ processor unit of the light signal system
4 memory unit
5 communication interface of the first vehicle
5′ communication interface of the second vehicle
5″ communication interface of the light signal system
6 detection unit
7 drive train
8 electric machine
9 battery
10 transmission
11 computer program product
12 GNSS sensor
13 MPC algorithm
14 longitudinal dynamic model
cost function
16 driver assistance system
17 internal combustion engine
18 second vehicle
19 processor unit of the driver assistance system
20 communication interface of the driver assistance system
21 road
22 radar sensor
23 front end of the first vehicle
24 rear end of the second vehicle
25 front end of the second vehicle
26 light signal system

1-10: (canceled)

11. A processor unit (3) for determining a trajectory for a first vehicle (1) by model predictive control and utilizing trajectory information about a second vehicle (18), wherein the processor unit (3) for the first vehicle (1) is configured for:
selecting first discretization points (P2, P3) from a totality of possible discretization points (P1, P2, P3) located within a virtual travel horizon of a model predictive control of the first vehicle (1);
transmitting the first discretization points (P2, P3) to a processor unit (3′) of the second vehicle (18), which is traveling ahead of the first vehicle (1), the first discretization points (P2, P3) located ahead of a rear end (24) of the second vehicle (18);
obtaining, from the processor unit (3′) of the second vehicle (18), an arrival time of the second vehicle (18) at each second discretization point (P3) ascertained by the processor unit (3′) of the second vehicle (18) from the first discretization points (P2, P3), the second discretization points (P3) located ahead of the second vehicle (18);
generating a trajectory data set for the first vehicle (1), the trajectory data set including the second discretization points (P3) selected by the second processor unit (3′) from the first discretization points (P2, P3) and the arrival times of the second vehicle (18) at the respective second discretization points (P3) ascertained by the second processor unit (3′), the trajectory data set also including zeroed value pairs, each of the zeroed value pairs including a first discretization point (P1, P2) that is not located ahead of the second vehicle as well as the value zero seconds; and
determine a trajectory for the first vehicle (1) via model predictive control by executing an MPC algorithm (13), which includes a longitudinal dynamic model (14) of the first vehicle (1) and a cost function (15), such that the cost function (15) is minimized, wherein the trajectory data set is taken into account as a constraint in the determination of the trajectory.

12. The processor unit (3) of claim 11, wherein the arrival times of the second vehicle (18) at the second discretization points (P3) establish minimum time periods, prior to the end of which the first vehicle (1) is not permitted to reach the respective second discretization point (P3).

13. The processor unit (3) of claim 11, wherein the processor unit (3) for the first vehicle (1) is configured for selecting the first discretization points (P2, P3) from the totality of possible discretization points (P1, P2, P3) such that the distance of the first discretization points (P2, P3) to the first vehicle (1) is greater than a distance between the first vehicle (1) and the second vehicle (18).

14. The processor unit (3) of claim 11, wherein the processor unit (3) for the first vehicle (1) is configured for:
receiving, from the second processor unit (3′) of the second vehicle (18), data corresponding to a length (I) of the second vehicle (18);
selecting third discretization points (P1, P2) from the first discretization points (P1, P2, P3), the distance of the third discretization points (P1, P2) to the first vehicle (1) being smaller than a sum of the length (I) of the second vehicle (18) and a distance between the first vehicle (1) and the second vehicle (18);
assigning the value zero seconds to each of the third discretization points (P1, P2); and
storing the value zero seconds for each of the third discretization points (P1, P2) as further zeroed value pairs in the trajectory data set.

15. The processor unit (3) of claim 11, wherein the processor unit (3) is configured for:
receiving a position (P4) and a switching time from the processor unit (3″) of a light signal system (26) that is located ahead of the first vehicle (1) and is configured for displaying traffic light signals (g, r), the switching time indicates when the light signal system (26) changes from a first traffic light signal (g) to a second traffic light signal (r); and
adding the position (P4) and the switching time of the light signal system (26) to the trajectory data set for the first vehicle (1).

16. The processor unit (3) of claim 15, wherein the switching time of the light signal system (26) received from the processor unit (3″) of the light signal system (26) establishes a maximum time period, prior to the end of which the first vehicle (1) must have reached the position (P4) of the light signal system (26).

17. A driver assistance system (16) for carrying out a driver assistance function of a first vehicle (1), wherein the driver assistance system (16) is configured for:
accessing a trajectory for the first vehicle (1) determined by the processor unit (3) of claim 11; and
carrying out a driver assistance function of the first vehicle (1) by utilizing the trajectory for the first vehicle (1).

18. A vehicle (1), comprising the processor unit (3) of claim 11.

19. A vehicle (1), comprising the driver assistance system (16) of claim 17.

20. A method for determining a trajectory for a first vehicle (1) by model predictive control and utilizing trajectory information about a second vehicle (18) traveling ahead of the first vehicle (1), the method comprising:
selecting, with a processor unit (3) of the first vehicle (1), first discretization points (P2, P3) from a totality of possible discretization points (P1, P2, P3) that are located within a virtual travel horizon of a model predictive control of the first vehicle (1), the first discretization points (P2, P3) located ahead of a rear end (24) of the second vehicle (18);
transmitting, by the processor unit (3) of the first vehicle (1), the first discretization points (P2, P3) to a processor unit (3′) of the second vehicle (18);
selecting, by the processor unit (3′) of the second vehicle (18), second discretization points (P3) from the first discretization points (P2, P3) such that all of the second discretization points (P3) are located ahead of the second vehicle (18);
ascertaining, by the processor unit (3′) of the second vehicle (18), an arrival time of the second vehicle (18) at each of the second discretization points (P3);
generating, by the processor unit (3) of the first vehicle (1), a trajectory data set for the first vehicle (1), the trajectory data set including the second discretization points (P3) and the arrival times of the second vehicle (18) at the respective second discretization points (P3) ascertained by the second processor unit (3′), the trajectory data set also including zeroed value pairs that each include a first discretization point (P1, P2) that is not located ahead of the second vehicle (18) as well as the value zero seconds; and
ascertaining, by the processor unit (3) of the first vehicle (1), a trajectory for the first vehicle (1) by executing an MPC algorithm (13), which includes a longitudinal dynamic model (14) of the first vehicle (1) and a cost function (15), by model predictive control such that the cost function (15) is minimized, wherein the trajectory data set is taken into account as a constraint in the determination of the trajectory.

21. A computer program product (11) for determining a trajectory for a first vehicle (1) by model predictive control and utilizing trajectory information about a second vehicle (18), wherein the computer program product (11), when run on a processor unit (3) of the first vehicle (1), instructs the processor unit (3) to:
select first discretization points (P2, P3) from a totality of possible discretization points (P1, P2, P3) located within a virtual travel horizon of a model predictive control of the first vehicle (1);
transmit the first discretization points (P2, P3) to a processor unit (3′) of the second vehicle (18) traveling ahead of the first vehicle (1), the first discretization points (P2, P3) located ahead of a rear end (24) of the second vehicle (18);
obtain, from the processor unit (3′) of the second vehicle (18), an arrival time of the second vehicle (18) at each second discretization point (P3) ascertained by the processor unit (3′) of the second vehicle (18) from the first discretization points (P2, P3), all second discretization points (P3) being located ahead of the second vehicle (18);
generate a trajectory data set for the first vehicle (1), the trajectory data set including the second discretization points (P3) and the arrival times of the second vehicle (18) at the respective second discretization points (P3) ascertained by the second processor unit (3′), the trajectory data set also including zeroed value pairs, the zeroed value pairs each including a first discretization point (P1, P2) that is not located ahead of the second vehicle as well as the value zero seconds; and
determine a trajectory for the first vehicle (1) via model predictive control by executing an MPC algorithm (13), which includes a longitudinal dynamic model (14) of the first vehicle (1) and a cost function (15), such that the cost function (15) is minimized, wherein the trajectory data set is taken into account as a constraint in the determination of the trajectory.
